(19) United States
(12) Patent Application Publication
(10) Pub. No.: US 2004/0202318 A1
(43) Pub. Date: Oct. 14, 2004

(54) Apparatus for supporting advanced encryption standard encryption and decryption

(76) Inventor: Chih-chung Lu, Shulin City (TW)

Correspondence Address: RABIN & Berdo, PC, 1101 14TH STREET, NW, SUITE 500, WASHINGTON, DC, 20005, US

(21) Appl. No.: 10/839,168

(22) Filed: May 6, 2004

Related U.S. Application Data
(63) Continuation-in-part of application No. 10/108,355, filed on Mar. 29, 2002.

(30) Foreign Application Priority Data
Dec. 5, 2003 (TW) 92134464
Oct. 4, 2001 (TW) 90124577

(51) Int. Cl. H04K 1/00

(52) U.S. Cl. 380/29

(57) ABSTRACT

An apparatus for supporting advanced encryption standard encryption and decryption combines bytes substitution and inverse bytes substitution operations, and includes first and second matrix operation devices, first and second exclusive-OR operation modules, first and second multiplexers, and a table-look-up device. The first multiplexer selects one from the outputs of the first matrix operation device and first exclusive-OR operation module. The second multiplexer selects one from the outputs of the second matrix operation device and second exclusive-OR operation module. The table-look-up device applies a common look-up table so as to save operation resources. In addition, the elements of the encryption apparatus are connected in a way such that the entire critical paths and complexity are reduced, thus improving the speed of the apparatus.

This is a continuation-in-part of Application No. 10/108,355 filed on Mar. 29, 2003, the contents of which are incorporated herein by reference. This continuation-in-part application claims the benefit of Taiwan application Serial No. 092134464, filed Dec. 5, 2003, the subject matter of which is incorporated herein by reference.

### BACKGROUND OF THE INVENTION

1. Field of the Invention

The invention relates in general to an apparatus for encryption and decryption, and more particularly to an apparatus for supporting encryption and decryption of advanced encryption standard (AES).

2. Description of the Related Art

Since the electronic-business (e-business) grows rapidly for the few years and the numbers of on-line transactions are increasing, data encryption is required to be much stricter for the sake of data security. A stricter encryption standard, advanced encryption standard (AES), has been developed after the widely used data encryption standard (DES) and is expected to be replaced for DES so as to fulfil the stricter data security requirement. An AES system is a symmetric-key system in which the sender and receiver of a message share a single, common key, thereafter called a subkey, which is used to encrypt and decrypt the message. The data length of a subkey may be chosen to be any of 128, 192, or 256 bits while a plaintext and a ciphertext can be such as 128 bits. For the sake of simplicity, hereinafter, plaintexts, ciphertexts, and subkeys are chosen to be 128 bits in length.

The AES system encrypts a plaintext according to the following encryption algorithm:

```
AddRoundKey
for round=1 to Nr−1
  KeyExpansion
  SubBytes
  ShiftRows
  MixColumns
  AddRoundKey
end for
SubBytes
ShiftRows
AddRoundKey
    Encryption Algorithm of AES
```

In this encryption algorithm, a round key addition operation (AddRoundKey) is first to perform a bitwise exclusive-OR (EX-OR) operation on the plaintext and the first subkey and to output the result of the EX-OR operation. Next, the algorithm proceeds to the following looping. The number of rounds of the looping is set to Nr−1 in which Nr is specified according to the AES specification. For each round, a key expansion operation (KeyExpansion) is performed to produce a new subkey based on a previous subkey. That is, in the first round of the looping, the first subkey is used to generate the second subkey by the KeyExpansion. After the KeyExpansion, a byte substitution operation (SubBytes) acts on the result of the AddRoundKey. Next, a row shifting operation (ShiftRows) is performed and then a column mixing operation (MixColumns) acts on the result of the ShiftRows. The first round is ended by performing the EX-OR operation on the result of the MixColumns and the current subkey, i.e., the second subkey. The looping are executed for the next round until the number of rounds of the looping is reached. As mentioned above, for each round, a new subkey is to be generated. For example, in the second round of the looping, the KeyExpansion is performed to generate the third subkey based on the second subkey. The generation of the other subkeys is done in the same way. When the looping is completed, the ciphertext is obtained by processing the result of the looping through the SubBytes, ShiftRows, and AddRoundKey.

The AES system decrypts the ciphertext according to the following decryption algorithm.

```
AddRoundKey
for round=1 to Nr−1
  InvKeyExpansion
  InvShiftRows
  InvSubBytes
  InvMixColumns
  AddRoundKey
end for
InvShiftRows
InvSubBytes
AddRoundKey
    Decryption Algorithm of AES
```

The operations in decryption are the inverse of the operations in encryption. The AES decryption includes the following steps. First, the inverse of AddRoundKey (InvAddRoundKey) is performed on the ciphertext and the previous subkey produced in the encryption above, for example, the 10^{th} subkey that is assumed to be the last produced subkey after the encryption operation, and to output the result of the InvAddRoundKey, wherein the result of the InvAddRoundKey is referred to as decryption input ciphertext, for the sake of brevity. Note that since the InvAddRoundKey is identical to the AddRoundKey due to the characteristic of EX-OR operation, InvAddRoundKey is hereinafter referred to as AddRoundKey. Next, the following looping is performed. For each round of the looping, the inverse of KeyExpansion (InvKeyExpansion) is performed on an input subkey to produce an output subkey based on the input subkey, where the output subkey, in the encryption, is the immediately produced subkey before the input subkey produced. For example, in the first round, the InvKeyExpansion is applied to the 10^{th} subkey (the input subkey) so as to produce the ninth subkey (the output subkey); in the second round, the application of InvKeyExpansion to the ninth subkey produces the eighth subkey; and so on. Next, the decryption input ciphertext is processed through the inverse of SubBytes (InvSubBytes), the inverse of ShiftRows (InvShiftRows), and the inverse of MixColumns (InvMixColumns). After that, AddRoundKey (i.e. InvAddRoundKey) is performed on the result of the last operation and the current subkey, resulting in the next decryption input ciphertext for the next round. The current key, for example, in the first round, is the ninth subkey after the application of InvKeyExpansion to the 10^{th} subkey. Afterward, the looping is performed until the number of round of the looping is reached. The decryption result is finally obtained by processing the result from the rounds of the looping through the InvSubBytes, InvShiftRows, and AddRoundKey.

As described above, the AES algorithm has five main operations, namely, AddRoundKey, KeyExpansion, SubBytes, ShiftRows, and MixColumns. These operations will be described in the following. For the sake of brevity, hereinafter, the description employs several notations. (1) The output of one operation is denoted by “out” while the input of the operation is denoted by “in”. (2) The notation “+” (or “⊕”) denotes bitwise exclusive-OR operation (EX-OR) other than addition. Since the five main operations are performed sequentially during the encryption/decryption and the output of an immediate operation (out) is as the input of its successive operation (in), these outputs and inputs of these operations will be denoted, for the sake of brevity, by out's and in's only, without names particularly denoted for them. In addition, plaintexts, ciphertexts, and subkeys have data lengths of 128 bits and are represented by 4×4 matrices with elements of 8 bits.

FIG. 1 illustrates the effect of AddRoundKey on data. As mentioned above, the operation of AddRoundKey is bitwise exclusive-OR (EX-OR) operation. The EX-OR is performed on an input data code (in) and a subkey (k), resulting in an output data code (out). By the characteristic of EX-OR operation, the input data code (in) is equal to the EX-OR operation of the output data code (out) and the subkey (k). In FIG. 1, AddRoundKey is illustrated in terms of respective elements and is represented as inN ⊕ kN=outN, where N is an integer indicative of the corresponding element's number. For the sake of brevity, this notation will hereinafter be adopted in the drawings.

FIG. 2 illustrates the effect of ShiftRows on data. In ShiftRows, the rows of an input data code (in), for example, the output of the AddRoundKey, is cyclically shifted to the right over different offsets. For example, the first row is not shifted (or shifted over zero byte), the second row is shifted to the right over one byte, the third row over two bytes, the fourth over three bytes and then the output of the ShifRows (out) is obtained as shown in the left of FIG. 2. If ShiftRows is in the way as in the example, the inverse of the ShiftRows (InvShiftRows) acts on its input data code in an inverse manner of the ShiftRows. That is, the first row of the input data code to InvShiftRows is not shifted (or shifted over zero byte), the second row is shifted to the left over one byte, the third over two bytes, and the fourth over three bytes.

FIG. 3 illustrates the effect of MixColumns/InvMixColumns on data. In MixColumns, every column of an input data code, e.g., obtained from the output of the ShiftRows, is transformed into the corresponding column of the output data code by the matrix multiplication of a specific multiplication matrix by the column. For example, the first column of the input data code (in) with elements in0, in1, in2, and in3 is multiplied by a 4×4 matrix in the upper of FIG. 3, resulting in the first column of the output of the MixColumns with elements out0, out1, out2, and out3. Conversely, the application of MixColumns to all columns of the output data code with the inverse of the specific multiplication matrix results in the input data code, e.g., as illustrated in the lower matrix multiplication. That is, InvMixColumns uses a specific multiplication matrix that is the inverse of the specific multiplication matrix for MixColumns.

FIG. 4 illustrates the effect of SubBytes/InvSubBytes on data. SubBytes is a non-linear byte substitution, operating on every byte of the input data code independently. The substitution table used in the substitution operation is called S-box, and the application of the S-box to each byte of the input data code (say x) results in one byte of data (say y). The operation of the S-box can be expressed as:

y=M*multiplicative_inverse(x)+c, (1)

where

$$M = ( \begin{matrix}1 & 1 & 1 & 1 & 1 & 0 & 0 & 0 \\ 0 & 1 & 1 & 1 & 1 & 1 & 0 & 0 \\ 0 & 0 & 1 & 1 & 1 & 1 & 1 & 0 \\ 0 & 0 & 0 & 1 & 1 & 1 & 1 & 1 \\ 1 & 0 & 0 & 0 & 1 & 1 & 1 & 1 \\ 1 & 1 & 0 & 0 & 0 & 1 & 1 & 1 \\ 1 & 1 & 1 & 0 & 0 & 0 & 1 & 1 \\ 1 & 1 & 1 & 1 & 0 & 0 & 0 & 1\end{matrix} )$$

Since the multiplicative inverse (multiplicative_inverse) is a complicated function, the mostly used approach to SubBytes is to use a look-up table to obtain y from x. As shown in FIG. 4, in SubBytes, each element of the output data code, such as out0, is obtained from an element of the input data code, such as in0, through a look-up table, which is represented by y=Table_A(x). Table_A is indicative of the substitution table, i.e., the S-box of AES. Conversely, the application of InvSubBytes to every element obtained from the SubBytes, such as out1, results in the corresponding element of the input data code for the SubBytes, such as in0, through an inverse look-up table, which is represented by x=Table_B(y). Table_B is indicative of the inverse substitution table, i.e., the inverse S-box of AES (inv-S-box). In practice, S-box and inv-S-box require substantial hardware, making them not economic to be implemented.

In implementation of AES, several main difficulties should be overcome. As described above, each of the algorithms of AES encryption and decryption has different processing steps, wherein inverse operations and non-linear substitution operations are involved. Particularly, SubBytes and InvSubBytes, the non-linear substitution operations, require referring to respective look-up tables. The implementation of the substitution operations will occupy substantial memory space (e.g., 2×16×256×8 bits) under the design requirement for high efficient encryption/decryption. In addition, MixColumns and InvMixColumns involve matrix multiplication. If they are not to be integrated effectively, their implementation will also occupy a substantial amount of operating resource. Thus, in implementation, these operations should be considered and redesigned as so to lower the hardware complexity and save the operating resource.

### SUMMARY OF THE INVENTION

It is therefore an object of the invention to provide a circuit module for supporting advanced encryption standard (AES) encryption and decryption, performing bytes substitution (SubBytes) and inverse bytes substitution (InvSubBytes) operations selectively. With a simplified structure, the circuit module benefits from the reduction of the entire critical paths and complexity, as well as the application of a common look-up table on each of the operations, thus improving the speed of operation and saving the operational resources.

It is another object of the invention to provide a round module for supporting AES encryption and decryption. The round module is used for performing a round for encryption and decryption selectively. With SubBytes and InvSubBytes, ShiftRows and InvShiftRows, and MixColumns and InvMixColumns integrated, the circuit module enables the implementation of an AES encryption and decryption apparatus to fulfil the requirements of high operation performance and reduced hardware complexity.

It is further object of the invention to provide an AES encryption and decryption system, fulfiling the requirements of high operation performance and reduced hardware complexity.

The invention achieves the above-identified objects by providing an apparatus for selectively performing byte substitution operation (SubBytes) and inverse byte substitution operation (InvSubBytes) on an input data code so as to output a required output data code, the apparatus supporting advanced encryption standard (AES). The apparatus comprises a first matrix operation module, a first exclusive-OR operation module, a first multiplexer, a table-lookup operation module, a second matrix operation module, a second exclusive-OR operation module, and a second multiplexer.

The first matrix operation module for performing a first matrix operation on the input data code and outputting the result of the first matrix operation. The first exclusive-OR operation module is used for performing a first exclusive-OR operation on the input data code and outputting the result of the first exclusive-OR operation. The first multiplexer, coupled to the first matrix operation module and the first exclusive-OR operation module, is employed for selecting either the result of the first exclusive-OR operation or the result of the first matrix operation, according to a selection signal, as an output data code of the first multiplexer. The table-lookup operation module, coupled to the first multiplexer, performs a table-lookup operation so as to output a table-lookup data code according to the output data code from the first multiplexer. The second matrix operation module, coupled to the table-lookup operation module, performs a second matrix operation on the table-lookup data code and outputting the result of the second matrix operation. The second exclusive-OR operation module is used for performing a second exclusive-OR operation on the table-lookup data code and outputting the result of the second exclusive-OR operation. The second multiplexer, coupled to the second matrix operation module and the second exclusive-OR operation module, selects one of the result of the second matrix operation and the result of the second exclusive-OR operation, according to the selection signal, as an output data code of the second multiplexer. The output data code from the second multiplexer is the required output data code for the apparatus.

The apparatus performs byte substitution operation when the selection signal is indicative of encryption, wherein the first multiplexer selects the result of the first exclusive-OR operation and the second multiplexer selects the result of the second exclusive-OR operation. The apparatus performs inverse byte substitution operation when the selection signal is indicative of decryption, wherein the first multiplexer selects the result of the first matrix operation and the second multiplexer selects the result of the second matrix operation.

The invention achieves the above-identified objects by providing a round module for supporting advanced encryption standard (AES) to perform encryption or decryption operation selectively on an input data code with a subkey and output an output data code. The round module comprises a bitwise exclusive-OR (EX-OR) device, a first multiplexer, a byte-substitution/inverse-byte-substitution operation (SubBytes/InvSubBytes), a row-shifting/inverse-row-shifting operation (ShiftRows/InvShiftRows) module, a second multiplexer, a column-mixing/inverse-column-mixing operation (MixColumns/InvMixColumns) module, a third multiplexer, a fourth multiplexer, and a fifth multiplexer.

The EX-OR device performs bitwise exclusive-OR (EX-OR) operation on the input data code and the subkey so as to output a first output code. The first multiplexer, coupled to the EX-OR device, according to a selection signal, selectively outputs one of the cipher data code and the first output code as a first product code. The SubBytes/InvSubBytes module, coupled to the first multiplexer, selectively performs byte-substitution/inverse-byte-substitution operation (SubBytes/InvSubBytes) on the first output code so as to output a substitution output code.

The SubBytes/InvSubBytes module comprises: a first matrix operation module for performing a first matrix operation on the first output code and outputting the result of the first matrix operation; a first exclusive-OR operation module for performing a first exclusive-OR operation on the first output code and outputting the result of the first exclusive-OR operation; a first selector, coupled to the first matrix operation module and the first exclusive-OR operation module, for selecting either the result of the first exclusive-OR operation or the result of the first matrix operation, according to the selection signal, as an output data code of the first selector; a table-lookup operation module, coupled to the first selector, for performing a table-lookup operation so as to output a table-lookup data code according to the output data code from the first selector; a second matrix operation module for performing a second matrix operation on the table-lookup data code and outputting the result of the second matrix operation; a second exclusive-OR operation module for performing a second exclusive-OR operation on the table-lookup data code and outputting the result of the second exclusive-OR operation; and a second selector, coupled to the second matrix operation module and the second exclusive-OR operation module, for selecting one of the result of the second matrix operation and the result of the second exclusive-OR operation, according to the selection signal, as the substitution output code.

The ShiftRows/InvShiftRows module, coupled to the SubBytes/InvSubBytes module, selectively performs row-shifting/inverse-row-shifting operation (ShiftRows/InvShiftRows) on the substitution output code so as to output a shifted code. The second multiplexer, coupled to the EX-OR device and the ShiftRows/InvShiftRows module, according to the selection signal, selectively outputs one of the first output code and the shifted code as a second product code. The MixColumns/InvMixColumns module, coupled to the second multiplexer, is used for selectively performing column-mixing/inverse-column-mixing operation (MixColumns/InvMixColumns) on the second product code so as to output a mixed code. The third multiplexer, coupled to the second multiplexer and the MixColumns/InvMixColumns module, according to a cipher detection signal, selectively outputs one of the second product code and the mixed code as a third product code, wherein the third product code is the cipher data code. The fourth multiplexer, coupled to the third multiplexer and the ShiftRows/InvShiftRows module, according to the selection signal, selectively outputs one of the shifted code and the cipher data code as a fourth product code. The fifth multiplexer, coupled to the fourth multiplexer and the EX-OR device, according to a round detection signal, selectively outputs one of the fourth product code and the first output code as the output data code for the apparatus.

The invention achieves the above-identified objects by providing an apparatus for performing advanced encryption standard (AES) encryption and decryption selectively on an input data code so as to produce an output data code. The apparatus comprises a round operation device, a key expansion operation device, and a key storage device.

The round operation device is used for performing a round operation with respect to either encryption or decryption selectively on an input code and a subkey so as to output a round operation output code. The key expansion operation device, coupled to the round operation module, is employed for generating the subkey for the round operation with respect to either encryption or decryption selectively, wherein the subkey is a desired subkey based on a given subkey. The key storage device, coupled to the round operation device and the key expansion operation device, is used for subkey storage and distribution so as to enable the round operation device and the key expansion operation device to perform the round operation.

The round operation device comprises a byte-substitution/inverse-byte-substitution operation (SubBytes/InvSubBytes) module, for selectively performing byte-substitution/inverse-byte-substitution operation (SubBytes/InvSubBytes) on an operation input code which is based on the input code and subkey received by the round operation device so as to output a substitution output code.

The SubBytes/InvSubBytes module comprises: a first matrix operation module for performing a first matrix operation on the operation input code and outputting the result of the first matrix operation; a first exclusive-OR operation module for performing a first exclusive-OR operation on the operation input code and outputting the result of the first exclusive-OR operation; a first selector, coupled to the first matrix operation module and the first exclusive-OR operation module, for selecting one from the result of the first exclusive-OR operation and the result of the first matrix operation, according to the selection signal, as an output code of the first selector; a table-lookup operation module, coupled to the first selector, for performing a table-lookup operation so as to output a table-lookup data code according to the output code of the first selector; a second matrix operation module for performing a second matrix operation on the table-lookup data code and outputting the result of the second matrix operation; a second exclusive-OR operation module for performing a second exclusive-OR operation on the table-lookup data code and outputting the result of the second exclusive-OR operation; and a second selector, coupled to the second matrix operation module and the second exclusive-OR operation module, for selecting one from the result of the second matrix operation and the result of the second exclusive-OR operation, according to the selection signal, as the substitution output code.

The key storage device receives the round operation output code and receives the subkey from the key expansion operation device; the key storage device outputs the given subkey to the key expansion operation device and outputs the input code to the round operation device; the key storage device buffers the input data code, performs subkey storage and distribution, receives the round operation output code and the subkey generated by the key expansion operation device, and outputs the output data code.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) illustrates the effect of AddRoundKey on data.

FIG. 2 (Prior Art) illustrates the effect of ShiftRows on data.

FIG. 3 (Prior Art) illustrates the effect of MixColumns/InvMixColumns on data.

FIG. 4 (Prior Art) illustrates the effect of SubBytes/InvSubBytes on data.

FIG. 5A is a block diagram of an integrated SubBytes/InvSubBytes module for supporting AES encryption and decryption.

FIGS. 5B-5D illustrate reduction of the integrated SubBytes/InvSubBytes module shown in FIG. 5.

FIG. 5E is a block diagram of a SubBytes/InvSubBytes module for supporting AES encryption and encryption according to a first embodiment of the invention.

FIG. 6 is a block diagram of an integrated MixColumns/InvMixColumns module for supporting AES encryption and encryption.

FIG. 7A illustrates the operation of determining the next subkey of an input subkey based on the input subkey.

FIG. 7B illustrates the operation of determining the previous subkey of an input subkey based on the input subkey.

FIG. 8 is a block diagram of a key expansion operation module.

FIG. 9 is a block diagram of a round module for supporting AES encryption and decryption, according to a second embodiment of the invention.

FIG. 10 is a block diagram of an apparatus for AES encryption and decryption according to a third embodiment of the invention.

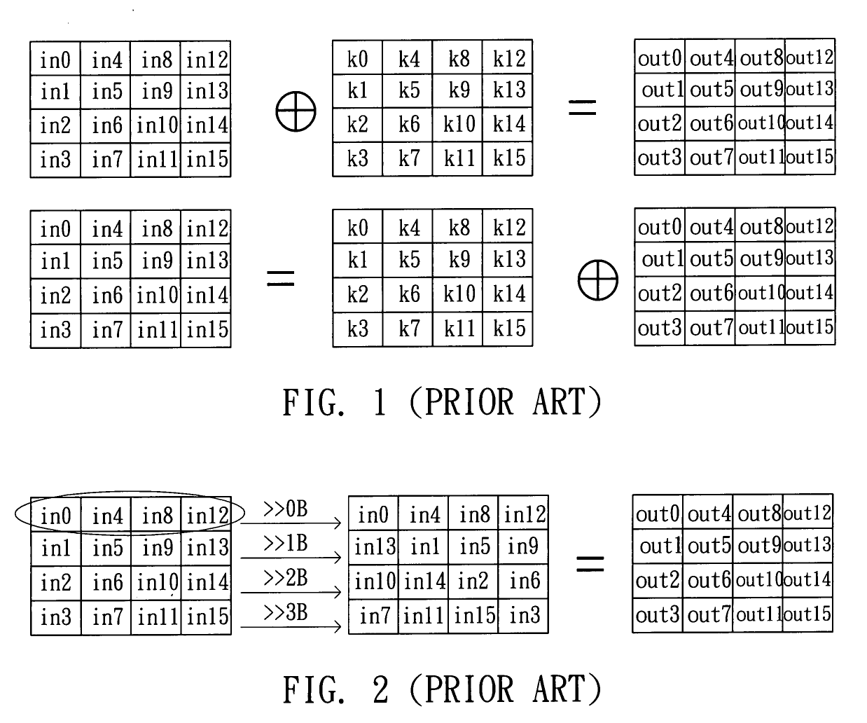

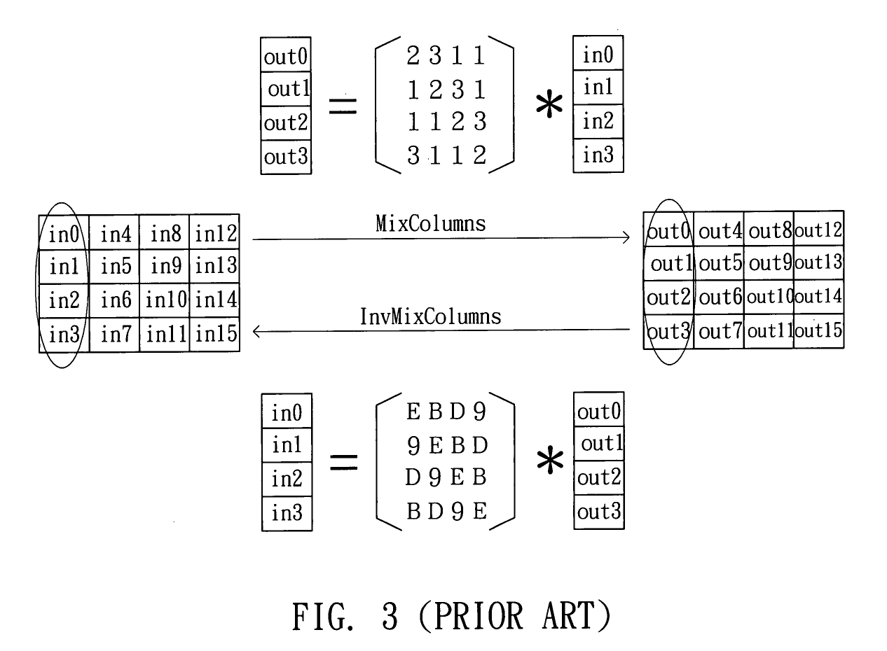

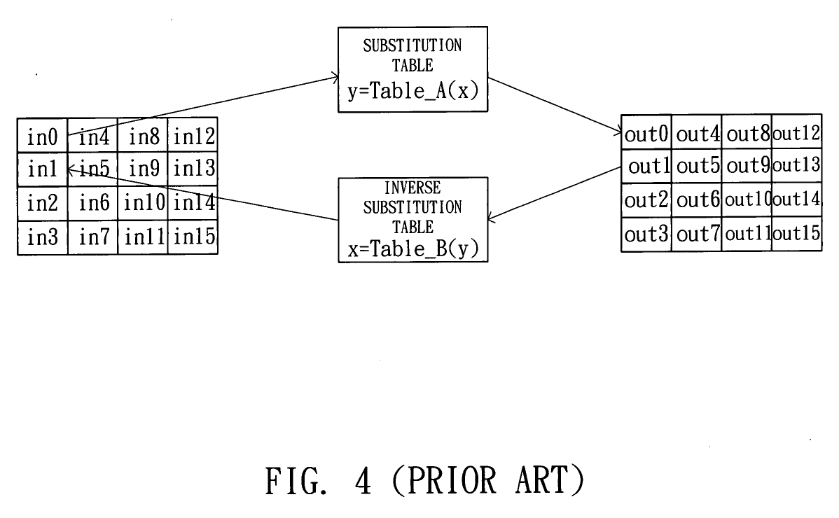

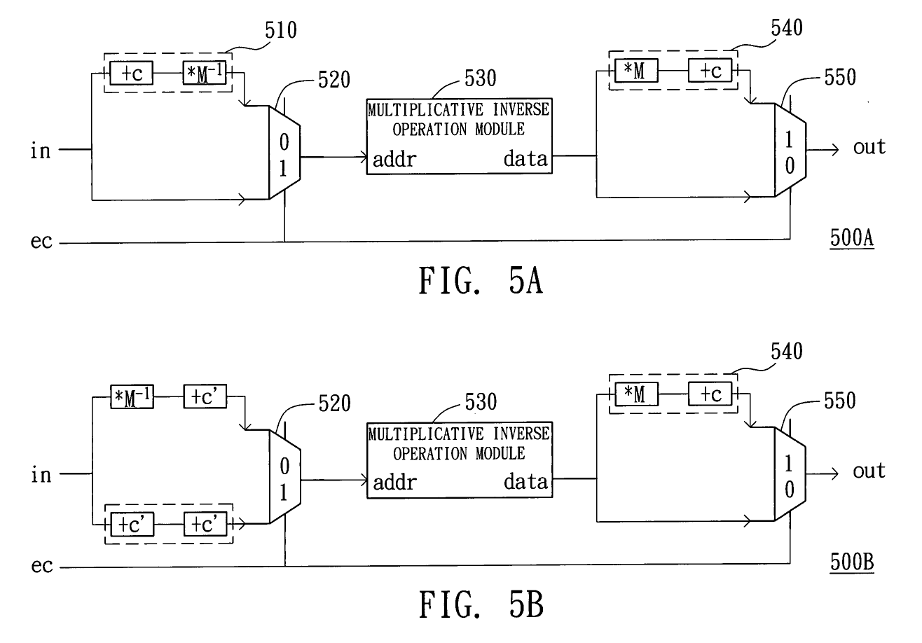

### DETAILED DESCRIPTION OF THE INVENTION

### Embodiment 1

In embodiment 1, the byte substitution operation (SubBytes) and the inverse of SubBytes are integrated and the integration is to be implemented with suitable hardware. For the sake of completeness, the equation (1) is repeated that:

y=M*multiplicative_inverse(x)+c, (1)

where

$$M = ( \begin{matrix}1 & 1 & 1 & 1 & 1 & 0 & 0 & 0 \\ 0 & 1 & 1 & 1 & 1 & 1 & 0 & 0 \\ 0 & 0 & 1 & 1 & 1 & 1 & 1 & 0 \\ 0 & 0 & 0 & 1 & 1 & 1 & 1 & 1 \\ 1 & 0 & 0 & 0 & 1 & 1 & 1 & 1 \\ 1 & 1 & 0 & 0 & 0 & 1 & 1 & 1 \\ 1 & 1 & 1 & 0 & 0 & 0 & 1 & 1 \\ 1 & 1 & 1 & 1 & 0 & 0 & 0 & 1\end{matrix} )$$

and c=[01100011]^{T}.

In implementation of SubBytes and InvSubBytes, a substantial amount of hardware resource will be occupied if SubBytes and InvSubBytes use respective tables in encryption and decryption. Accordingly, it is desirable to obtain a simplified equation so as to reduce the hardware complexity. From equation (1), the inverse operation of equation (1) is obtained as follows:

x=multiplicative_inverse⁻¹(M⁻¹*(y+c)). (2)

Since multiplicative_inverse( ) is equivalent to multiplicative_inverse⁻¹( ), the equation (2) can be expressed as:

x=multiplicative_inverse(M⁻¹*(y+c)). (3)

By the inverse matrix operation, the M⁻¹ is determined as:

$${M}^{′} = {M}^{- 1} = ( \begin{matrix}0 & 1 & 0 & 1 & 0 & 0 & 1 & 0 \\ 0 & 0 & 1 & 0 & 1 & 0 & 0 & 1 \\ 1 & 0 & 0 & 1 & 0 & 1 & 0 & 0 \\ 0 & 1 & 0 & 0 & 1 & 0 & 1 & 0 \\ 0 & 0 & 1 & 0 & 0 & 1 & 0 & 1 \\ 1 & 0 & 0 & 1 & 0 & 0 & 1 & 0 \\ 0 & 1 & 0 & 0 & 1 & 0 & 0 & 1 \\ 1 & 0 & 1 & 0 & 0 & 1 & 0 & 0\end{matrix} ) . \qquad ( 4 )$$

Thus, equation (3) can be expressed as:

x=multiplicative_inverse(M′*(y+c)). (5)

As examined from equations (1) and (5), a common look-up table,

i.e., multiplicative_inverse( ), is employed so the S-box and inverse S-box can be integrated to reduce the hardware requirements for SubBytes and InvSubBytes.

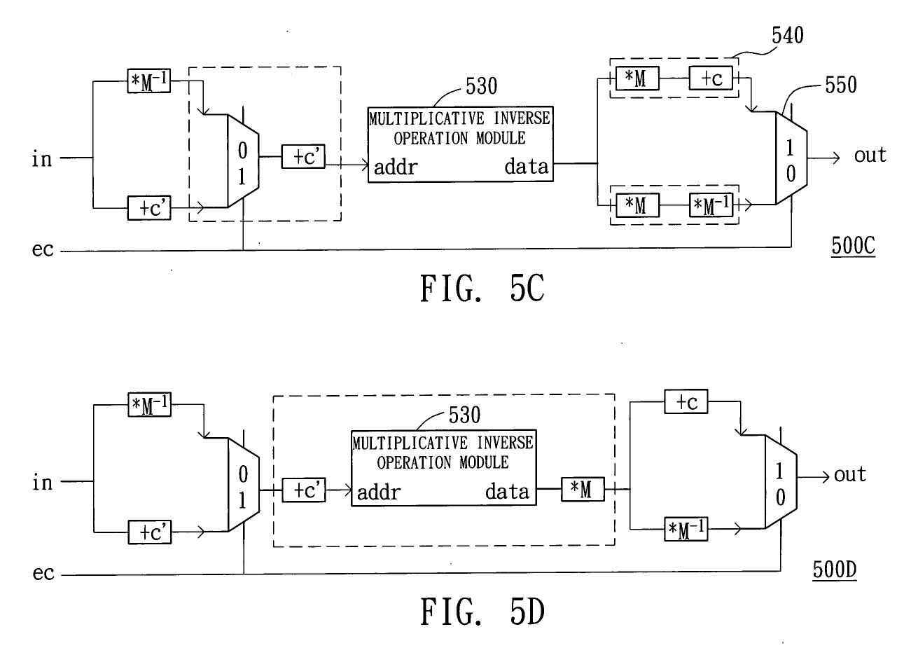

FIG. 5 shows an integrated SubBytes/InvSubBytes module for supporting AES encryption and decryption. As shown in FIG. 5, a SubBytes/InvSubBytes module 500A includes a matrix operation module 510, a multiplexer 520, a multiplicative inverse operation module 530, a matrix operation module 540, and a multiplexer 550. The multiplicative inverse operation module 530 performs the operation of the multiplicative inverse defined by: data=multiplicative_inverse(addr), and is implemented by way of table lookup. That is, by referring to the look-up table according to an input code, i.e. addr, the operation result, i.e. data, is obtained. The matrix operation module 510 performs the operation of the equation: out=(in+c)*M′ while the matrix operation module 540 is for performing the operation of the equation: out=data*M+c, wherein M and M⁻¹ are expressed, for example, as above.

When SubBytes is to be performed, a selection signal, designated as ec, is set to 1. When the selection signal ec is set to 1, the input data code, i.e. “in”, is fed into the multiplicative inverse operation module 530, via the multiplexer 520, so as to output a table-lookup data code, i.e. multiplicative_inverse(in), by referring to the look-up table. The matrix operation module 540 then performs the operation of the equation, out=in*M+c, on the table-lookup data code, thus completing the SubBytes.

Conversely, when InvSubBytes is to be performed, the selection signal ec is set to 0. Next, the input data code, i.e. “in”, is fed into the matrix operation module 510 so as to perform the operation of the equation: out=(in+c)*M′. The output of the matrix operation module 510 is fed into the multiplicative inverse operation module 530 and the table-lookup data code is obtained through table look-up, thereby completing the InvSubBytes.

The SubBytes/InvSubBytes module 500A performs the functions of both S-box and inverse S-box with only one look-up table so that the amount of hardware for implementation of SubBytes and InvSubBytes has a significant decrease of 57%, as compared with the original hardware requirements without the functional integration.

Improvements can be made to the paths with respect to the multiplexer 550 on the right side of FIG. 5A. First, an operation module can be added to the lower path fed into the multiplexer 550 without affecting the final output of the SubBytes/InvSubBytes module 500A. The operation module is defined as:

x=multiplicative_inverse(M″*(y+c″)), (5.1)

where y and x are tge resoectuve input and output of the operation module, and

$${M}^{″} = ( \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0 \\ 0 & 0 & 0 & 0 & 0 & 0 & 0 & 1\end{matrix} ) \qquad {c}^{″} = ( \begin{matrix}0 \\ 0 \\ 0 \\ 0 \\ 0 \\ 0 \\ 0 \\ 0\end{matrix} ) .$$

Next, the multiplexer 550 and the matrix operation module 540 in FIG. 5A are replaced by a new operation module defined as:

x=multiplicative_inverse(M(e)*(y+c(e))) (5.2)

where

$$M ( e ) = ( \begin{matrix}1 & e & e & e & e & 0 & 0 & 0 \\ 0 & 1 & e & e & e & e & 0 & 0 \\ 0 & 0 & 1 & e & e & e & e & 0 \\ 0 & 0 & 0 & 1 & e & e & e & e \\ e & 0 & 0 & 0 & 1 & e & e & e \\ e & e & 0 & 0 & 0 & 1 & e & e \\ e & e & e & 0 & 0 & 0 & 1 & e \\ e & e & e & e & 0 & 0 & 0 & 1\end{matrix} ) \qquad c ( e ) = ( \begin{matrix}0 \\ e \\ e \\ 0 \\ 0 \\ 0 \\ e \\ e\end{matrix} ) .$$

That is, a modified inverse-optional S-box module is obtained.

The improvements to the circuit of FIG. 5A are made so as to achieve the reduction of elements, thus failing to show significant improvements in reducing critical paths or complexity of the module.

According to the purpose of the invention, an improvement on the integrated SubBytes/InvSubBytes module 500A is obtained to achieve reduced critical paths and less complexity, thereby enhancing the entire performance of the encryption and decryption.

First, the order of the two operations, i.e. +c and *M⁻¹, on the left side of FIG. 5A are changed substantially. That is, (in+c)*M⁻¹=in*M⁻¹+c*M₋₁=in*M⁻¹+c′, where c′=c*M⁻¹. Next, since the symbol “+” represents XOR operation in AES, in=in+c′ +c′. By using the above two approaches, an integrated SubBytes/InvSubBytes module 500B, as shown in FIG. 5B, is obtained from the structure of the module 500A shown in FIG. 5A, without deviating from the intended purpose and final output of SubBytes/InvSubBytes.

Further, as shown in FIG. 5C, another integrated SubBytes/InvSubBytes module 500C is obtained from the one shown in FIG. 5B by applying two additional conversions as follows. One conversion is to place one of the +c′ operation modules on the input side of the left multiplexer in FIG. 5B into its output side. On the lower path of the input side of the multiplexer 550 in FIG. 5B, the operations *M and *M⁻¹ are added since data=data * M * M⁻¹. Without deviating from the intended purpose and final output of SubBytes/InvSubBytes, the integrated SubBytes/InvSubBytes module 500C is obtained.

In FIG. 5D, an integrated SubBytes/InvSubBytes module 500D is obtained from the structure in FIG. 5C by reducing the two *M operations on the input side of the multiplexer 550 from two to one and dispose the one on the output of the multiplicative inverse operation module 530.

A final structure is achieved in FIG. 5E by using a new look-up table into which the three different operations indicated by the dashed-line rectangle are integrated. The new look-up table is obtained through the computation of the three operations with different input and output.

FIG. 5E shows an integrated SubBytes/InvSubBytes module 500E, which is an apparatus supporting AES for selectively performing byte substitution operation (SubBytes) and inverse byte substitution operation (InvSubBytes) on an input data code, denoted by “in”, so as to output a required output data code, denoted by out. The apparatus 500E comprises a first matrix operation module 561, a first exclusive-OR operation module 565, a first multiplexer 520, a table-lookup operation module 590, a second matrix operation module 571, a second exclusive-OR operation module 575, and a second multiplexer 550.

The first matrix operation module 561 is used for performing a first matrix operation, for example, the *M⁻¹ operation as described above, on the input data code, for example, input data code “in”, and outputting the result of the first matrix operation. The first exclusive-OR operation module 565 is employed for performing a first exclusive-OR operation, for example, the +c′ operation as described above, on the input data code and outputting the result of the first exclusive-OR operation. The first multiplexer 520 is coupled to the first matrix operation module 561 and the first exclusive-OR operation module 565. The first multiplexer 520, according to a selection signal, such as selection signal ec, selects either the result of the first exclusive-OR operation or the result of the first matrix operation as the output data code of the first multiplexer 520. The table-lookup operation module 590, coupled to the first multiplexer 520, is employed for performing a table-lookup operation so as to output a table-lookup data code according to the code fed into “addr”, i.e. the output data code from the first multiplexer 520. The second matrix operation module 571, coupled to the table-lookup operation module 590, is used for performing a second matrix operation, for example, the *M⁻¹ operation, on the table-lookup data code and outputting the result of the second matrix operation. The second exclusive-OR operation module 575, coupled to the table-lookup operation module 590, is used for performing a second exclusive-OR operation on the table-lookup data code, for example, the +c operation, and outputting the result of the second exclusive-OR operation. The second multiplexer 550 is coupled to the second matrix operation module 571 and the second exclusive-OR operation module 575. The second multiplexer 550, according to the selection signal, for example, selection signal ec, is employed for selecting one of the result of the second matrix operation and the result of the second exclusive-OR operation as an output data code of the second multiplexer 550. The output data code from the second multiplexer 550 is the required output data code “out” for the apparatus 500E.

The apparatus 500E performs byte substitution operation when the selection signal is indicative of encryption, for example, when selection signal ec is set to a high level (e.g. 1), wherein the first multiplexer 520 selects the result of the first exclusive-OR operation and the second multiplexer 550 selects the result of the second exclusive-OR operation. The apparatus 500E performs inverse byte substitution operation when the selection signal is indicative of decryption, for example, when selection signal ec is set to a low level (e.g. 0), wherein the first multiplexer 520 selects the result of the first matrix operation and the second multiplexer 550 selects the result of the second matrix operation.

In embodiment 1, the first matrix operation is substantially identical to the second matrix operation, namely, the *M⁻¹ operation. The first exclusive-OR operation has an operand, such as the c′ operand in embodiment 1, based on the first matrix operation (e.g. the M⁻¹ operation) and the second exclusive-OR operation (e.g. the +c operation). In addition, the table-lookup operation module 590 has a look-up table based on a multiplicative inverse operation, the first matrix operation, and the first exclusive-OR operation. As in embodiment 1, the look-up table is based on Multiplicative_inverse( ), the +c′ operation, and the *M operation.

The apparatus 500E shown in FIG. 5E has two significant advantages over the original structure in FIG. 5A, as follows: (1) reduced entire critical paths, which result in enhanced operational performance; and (2) less hardware complexity of implementation, wherein the *M⁻¹ operation is less complex than the *M operation because the number of element 1 of matrix M⁻¹ is only about ⅗ that of element 1 of matrix M. With at least the two advantages, the integrated SubBytes/InvSubBytes module 500E has less hardware complexity and better operational performance, as compared with the original structure in FIG. 5A.

### Embodiment 2

In embodiment 2, an integrated AES encryption/decryption algorithm for and its hardware implementation for round operation are provided. The encryption/decryption algorithm can be expressed by the pseudo-C code as follow:

```
if (ec = = 0) for (i = 0; i < round; i++)
    Inv_Opt_keyexpansion(key,1); //inverse key
for (i = 0; i <= Nr; i++)
{ addroundkey;
  if (i = = Nr) break;
  Inv_Opt_keyexpansion(key, ec);
  if (ec = = 1)
  { Inv_Opt_subbytes(ec);
    Inv_Opt_shiftrows(ec);
    if (i < (Nr−1)) Inv_Opt_mixcolumns(ec);
  } else
  { if (i > 0) Inv_Opt_mixcolumns(ec);
    Inv_Opt_subbytes(ec);
    Inv_Opt_shiftrows(ec);
  }
}
```

wherein Nr is referred to as the number of rounds. When a 128-bit AES encryption/decryption (AES-128) is performed, Nr is set to 10. When 192- or 256-bit AES encryption/decryption is performed, Nr is set to 12 or 14, respectively.

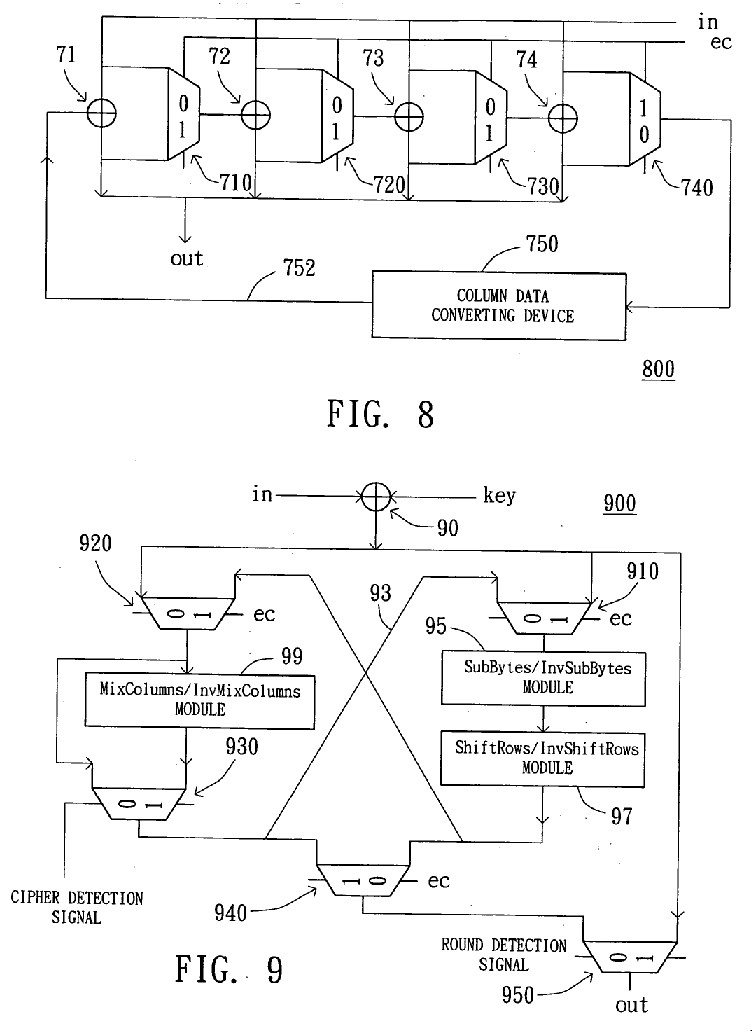

Referring to FIG. 9, a round module supporting AES encryption/decryption implements the above algorithm, according to embodiment 2 of the invention. The round module 900 includes an EX-OR gate 90, a SubBytes/InvSubBytes module 95, a ShiftRows/InvShiftRows module 97, a MixColumns/InvMixColumns module 99, and multiplexers 910, 920, 930, 940, and 950, wherein the implementation of the SubBytes/InvSubBytes module 95 is provided as shown in FIG. 5E, for example.

The round module 900 is configured to perform encryption by setting the selection signal ec to 1. First, an input data code “in”, i.e. a plaintext, and a subkey are fed into the EX-OR gate 90 to perform AddRoundKey. The multiplexer 910, according to the selection signal ec, outputs the result of the AddRoundKey into the SubBytes/InvSubBytes module 95 to perform SubBytes. The result of the SubBytes is then fed into the ShiftRows/InvShiftRows module 97 to perform ShiftRows. Next, according to the selection signal ec, the multiplexer 920 feeds the result of the ShiftRows into the MixColumns/InvMixColumns module 99 to perform MixColumns. The result of the MixColumns and the result of the ShiftRows are fed into input terminal 0 and input terminal 1 of the multiplexer 930, respectively. According to a cipher detection signal, the multipixer 930 selects one data code from the two input terminals as its output data code. The cipher detection signal corresponds to determination expressions in the above encryption/decryption algorithm. For a 128-bit AES encryption, where Nr is equal to 10, the cipher detection signal, for example, can be generated by the following determination expression or a circuit that implements the boolean expression:

˜((ec&(i==4′d9))|(˜ec&(i==4′d0))).

In this way, when the cipher detection signal is equal to 1, the multiplexer 930 outputs the output data from the MixColumns/InvMixColumns module 99; when the cipher detection signal is equal to 0, the multiplexer 930 outputs the output data from the multiplexer 920. The output data from the multiplexer 930 is called cipher data code 93 for the sake of simplicity. As shown in FIG. 9, the cipher data code 93 is fed into both the input terminal 0 of the multiplexer 910 and the input terminal 1 of the multiplexer 940. Since the selection signal ec is equal to 1, the multiplexer 940 outputs the cipher data code 93 to the input terminal 0 of the multiplexer 950. The input terminal 1 of the multiplexer 950 is for receiving the output data from the EX-OR gate 90. According to a round detection signal, the multiplexer 950 selects one data code from its two input terminals as its output data code. The round detection signal is generated by determining whether the number of rounds reaches to Nr. In this example, Nr is set to 10 so that the round detection signal can be expressed as boolean expression (i==4′d10). That is, the round detection signal is equal to 1 when boolean expression (i==4′d10) is true; otherwise, the round selection signal is equal to 0. When the round detection signal is equal to 0, the multiplexer 950 outputs the output data from the multiplexer 940. The output data from the multiplexer 940 is then fed into the round module 900 as the input data code “in” for the next round of encryption. In addition, Inv_Opt_keyexpansion(key,ec) performs Key Expansion operation to produce the next subkey. According to the looping design of the above encryption/decryption algorithm, the round module 900 repeats AddRoundKey, SubBytes, ShiftRows, and MixColumns, and so on for encryption until the boolean expression (i==4′d9) is true. When i is equal to 4′d9, the cipher detection signal is equal to 0 since ec is equal to 1, resulting in the multiplexer 930 outputting the output data from the multiplexer 920. The output data from the multiplexer 920 is then outputted through the multiplexers 940 and 950, as the next input data code “in”. Afterwards, as boolean expression (i==4′d10) is true, AddRoundKey is performed on the input data code “in” and subkey, and the multiplexer 950 selects the output of the AddRoundKey since the round detection signal, defined by boolean expression (i==4′d10), is equal to 1. The encryption procedure is ended and the output of the multiplexer 950 is the required ciphertext.

Conversely, the round module 900 is configured to perform decryption by setting the selection signal ec to 0. An input data code “in”, i.e. a ciphertext, and a subkey, i.e. the last subkey for the ciphertext, are fed into the EX-OR gate 90 to perform AddRoundKey. The multiplexer 920, according to the selection signal, outputs the result of the AddRoundKey into the MixColumns/InvMixColumns module 99 so as to perform InvMixColumns. In addition, the result of the AddRoundKey and the result of the InvMixColumns are fed into the input terminal 0 and input terminal 1 of the multiplexer 930, respectively. The multiplexer 930, according to the cipher detection signal, selects one data code from the two input terminals, wherein the cipher detection signal is defined above. When the cipher detection signal is equal to 1, the multiplexer 930 outputs the output data from the MixColumns/InvMixColumns module 99. When the cipher detection signal is equal to 0, the multiplexer 930 outputs the output data from the multiplexer 920. The output data from the multiplexer 920 is referred to as a cipher data code 93. Since the selection signal is equal to 0, the multiplexer 910 outputs the cipher data code 93 to the SubBytes/InvSubBytes module 95 to perform InvSubBytes. The result of the InvSubBytes is fed into the ShiftRows/InvShiftRows module 97 to perform InvShiftRows. The result of the InvShiftRows is then outputted through the multiplexer 940 since the selection signal is equal to 0. Next, the multiplexer 950, according to the round detection signal, selects one data code from its two input terminals as its output data code. When the round detection signal is equal to 0, the multiplexer 950 outputs the output data from the multiplexer 940. The output data from the multiplexer 940 is then fed into the round module 900 as the input data code “in” for the next round of decryption. In addition, Inv_Opt_keyexpansion(key,ec) performs Key Expansion operation to produce the next subkey. According to the looping design of the above encryption/decryption algorithm, the round module 900 repeats AddRoundKey, InvMixColumns, InvSubBytes, and InvShiftRows, and so on for decryption until boolean expression (i==4′d9) is true. When i is equal to 4′d9, the cipher detection signal is equal to 0, resulting in the multiplexer 930 outputting the output data from the multiplexer 920 to the multiplexer 910. The multiplexer 910 feeds the output data from the multiplexer 920 into the SubBytes/InvSubBytes module 95 to perform InvSubBytes. The result of the InvSubBytes is then fed into ShiftRows/InvShiftRows module 97 to perform InvShiftRows. Next, the result of the InvShiftRows is outputted through the multiplexers 940 and 950, as the next input data code “in”. Afterwards, as boolean expression (i==4′d10) is true, AddRoundKey is performed on the input data code “in” and subkey, and the multiplexer 950 selects the output of the AddRoundKey since the round detection signal, defined by boolean expression (i==4′d10), is equal to 1. The decryption procedure is ended and the output of the multiplexer 950 is the required plaintext.

### Embodiment 3

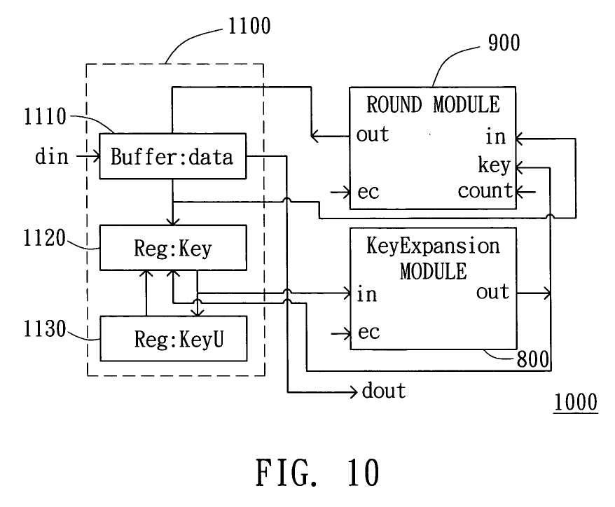

According to embodiment 3 of the invention, an AES encryption and decryption apparatus is provided based on the above round module, for selectively performing AES encryption and decryption. Referring to FIG. 10, the AES encryption and decryption apparatus 1000 comprises a key expansion operation (KeyExpansion) module 800, a round module 900, and a key storage device 1100. The key storage device 1100 comprises three memory devices 1110, 1120, and 1130 for storing data, key, and backup key, respectively. As an example in FIG. 10, the memory devices 1110, 1120, and 1130 are a buffer for storing data, a register for storing subkey, and a register for storing backup key, respectively. In FIG. 10, “din” represents an input data code and “dout” represents the output data code.

The key storage device 1100, coupled to the round module 900 and the KeyExpansion module 800, is used for subkey storage and distribution so as to enable the round module 900 and the KeyExpansion module 800 to perform the round operation. The key storage device 1100 provides an input data code “in” for the round module 900, receives an output data code “our” from the round module 900, and stores the output data code “out” from the round module 900 in the memory device 1110. The key storage device 1100 also provides an input data code “in” for the KeyExpansion module 800, receives an output data code “out” from the KeyExpansion module 800, and stores the output data code “out” from the KeyExpansion module 800 in the memory device 1120. The output data code “out” from the KeyExpansion module 800, a subkey, is fed into a terminal of the round module 900, key, as the subkey for the round module 900.

When encryption is required, the AES encryption and decryption apparatus 1000 is configured to perform encryption by setting the selection signal “ec” to 1. Accordingly, the round module 900 and the SubBytes/InvSubBytes module 95 of the round module 900 are configured to perform encryption, as in embodiments 1 and 2. A current number of rounds for encryption is consecutively fed into the count terminal of the round module 900 in FIG. 10. In this case, “din” represents a plaintext to be encrypted and “dout” represents the ciphertext outputted by the AES encryption and decryption apparatus 1000 after encrypting the plaintext.

When decryption is required, the AES encryption and decryption apparatus 1000 is configured to perform decryption by setting the selection signal “ec” to 0. In this case, “din” represents a ciphertext to be decrypted and “dout” represents the required plaintext outputted by the AES encryption and decryption apparatus 1000 after decrypting the ciphertext.

Further, backup of subkeys is necessary to facilitate encryption and decryption before encryption or decryption begins because the subkeys used in encryption and decryption are in reverse order. A subkeys backup rule is presented in TABLE 1. When a task that the AES encryption and decryption apparatus 1000 is required to perform is the same type, e.g. encryption or decryption indicated by the selection signal “ec”, as the last one, the key transfer process Reg:Key<=Reg:KeyU is performed; otherwise, Reg:KeyU<=Reg:Key is performed. Subkeys in the key registers, i.e. memory devices 1120 and 1130, change for each round, as shown in TABLE 2, where AES-128, i.e. 128-bit AES encryption and decryption, is performed. In this way, on completion of an encryption or decryption operation, subkey_0 or subkey_10 is stored in the two key registers, thereby facilitating the next task, i.e. encryption or decryption.

TABLE 1
Subkeys backup rule

| Start | Key transfer process |
|---|---|
| Current_ec == previous_ec | Reg:Key <= Reg:KeyU |
| Current_ec != previous_ec | Reg:KeyU <= Reg:Key |

TABLE 2
Subkey change process for each round

| | Encryption | | Decryption | |
|---|---|---|---|---|
| Round | Reg: Key | Reg: KeyU | Reg: Key | Reg: KeyU |
| Start | sub_key_0 | sub_key_0 | sub_key_10 | sub_key_10 |
| (key backup) | | | | |
| 1 | sub_key_1 | sub_key_0 | sub_key_9 | sub_key_10 |
| 2 | sub_key_2 | sub_key_0 | sub_key_8 | sub_key_10 |
| 3 | sub_key_3 | sub_key_0 | sub_key_7 | sub_key_10 |
| 4 | sub_key_4 | sub_key_0 | sub_key_6 | sub_key_10 |
| 5 | sub_key_5 | sub_key_0 | sub_key_5 | sub_key_10 |
| 6 | sub_key_6 | sub_key_0 | sub_key_4 | sub_key_10 |
| 7 | sub_key_7 | sub_key_0 | sub_key_3 | sub_key_10 |
| 8 | sub_key_8 | sub_key_0 | sub_key_2 | sub_key_10 |
| 9 | sub_key_9 | sub_key_0 | sub_key_1 | sub_key_10 |
| 10 (end) | sub_key_10 | sub_key_0 | sub_key_0 | sub_key_10 |

In the following, hardware implementation of MixColumns/InvMixColumns module 99 in FIG. 9 and the KeyExpansion in FIG. 10 is provided.

In the example, the operation of mixing columns (MixColumns) and the inverse of MixColumns are integrated and the functional integration is to be implemented with suitable hardware. In the operations of MixColumns and InvMixColumns, two main calculations are defined by the following two equations:

outx=[2 3 1 1]*[a b c d]^{T} and (6)

outy=[14 11 13 9]*[a b c d]^{T}. (7)

After being ungrouping, the two equations above can be expressed as:

outx=2(a+b)+b+(c+d) and (8)

outy=4(a+b)+2(c+d)+(a+c))+

2(a+b)+b+(c+d). (9)

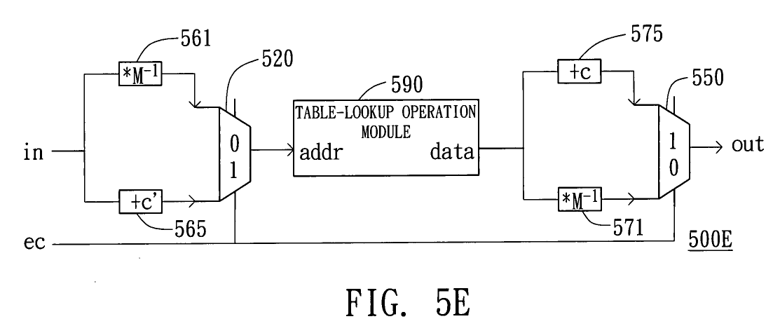

The operation for obtaining the results of equations (8) and (9) are listed in TABLE 3. Execution of the first five steps listed results in outx, and then executing the five steps after obtaining outx results in outy. Accordingly, in implementation, as shown in FIG. 6, the hardware for the first five steps can be used for obtaining both results of the equations above, reducing the hardware complexity and saving operating resource.

TABLE 3

| step | Operations |
|---|---|
| 1 | w1 = a + b |
| 2 | w2 = a + c |
| 3 | w3 = c + d |
| 4 | w4 = 2 * w1 |
| 5 | outx = b + w3 + w4 |
| 6 | w5 = 2 * w3 |
| 7 | w6 = w2 + w4 + w5 |
| 8 | w7 = 2 * w6 |
| 9 | w8 = 2 * w7 |
| 10 | outy = w8 + outx |

FIG. 6 illustrates an integrated MixColumns/InvMixColumns module, capable of use in encryption and decryption of AES, in block diagram form. A MixColumns/InvMixColumns module 600 includes a number of EX-OR gates and multipliers, wherein the EX-OR gates and multipliers are coupled according to the operations listed in TABLE 3. Each of the EX-OR gates performs EX-OR operation on two respective input data codes while each of the multipliers doubles the value of its respective input data codes. The MixColumns/InvMixColumns module 600 has four inputs, namely, a, b, c, and d, and two outputs, namely, outx and outy. Since the connections among the EX-OR gates and multipliers are illustrated as the listed operations, the details of connections will not be described, for the sake of brevity. In the following description, the operation of the MixColumns/InvMixColumns module 600 is described.

In MixColumns and InvMixColumn, matrix multiplication is performed on every column of the respective input data codes (in matrix form). Suppose that an input data code is of the type of 4×4 matrix. Since there are four elements on each column, for the sake of simplicity, the four elements are denoted by code(a), code(b), code(c), and code(d), respectively, and correspond to a, b, c, and d shown in FIG. 6. Referring to TABLE 3, the steps of performing MixColumns are described as follows. Step 1 can be implemented by using EX-OR gate 61 to perform EX-OR on the code(a) and code(b) and to output data W1. Step 2 can be implemented by using EX-OR gate 62 to perform EX-OR operation on the code(a) and code(c) and to output data W2. Step 3 can be implemented by using EX-OR gate 63 to perform EX-OR operation on the code(c) and code(d) and to output data W3. Step 4 can be implemented by using multiplier 621 to perform multiplication of the output data W3 from the EX-OR gate 61 by two and to output data W4. Step 5 can be implemented by using EX-OR gate 64 to perform EX-OR operation on the code(b) and data W3, and then by using EX-OR gate 65 to perform EX-OR operation on the output data from the EX-OR gate 64 and the data W4 from the multiplier 621, wherein the output data from the EX-OR gate 65 is the result (outx) from the MixColumns/InvMixColumns module 600 performing MixColumns on the row with the elements code(a), code(b), code(c), and code(d).

The steps of performing InvMixColumns are as follows. As mentioned above, the first five steps for InvMixColumns are identical to the steps of MixColumns, and the description for InvMixColumns proceeds with step 6. Step 6 can be implemented by using multiplier 622 to multiply the output data W3 from the EX-OR gate 63 by two and to output data W5. Step 7 can be implemented by using EX-OR gate 66 to perform EX-OR operation on the data W2 and W5, and then by using EX-OR gate 67 to perform EX-OR operation on the output data from the EX-OR gate 66 and the data W4 from the multiplier 621 and to output data W6. Step 8 can be implemented by using multiplier 623 to multiply the data W6 from the EX-OR gate 67 by two and to output data W7. Step 9 can be implemented by using multiplier 624 to multiply the data W7 from the multiplier 623 by two and to output data W8. Step 10 can be implemented by using EX-OR gate 68 to perform EX-OR operation on the output data from the EX-OR gate 65 and the data W8, wherein the output data from the EX-OR gate 68 is the result (outy) from the integrated MixColumns/InvMixColumns module 600 performing InvMixColumns on the row with the elements code(a), code(b), code(c), and code(d).

Note that hardware complexity is greatly reduced because the first five steps are common to MixColumns and InvMixColumns.

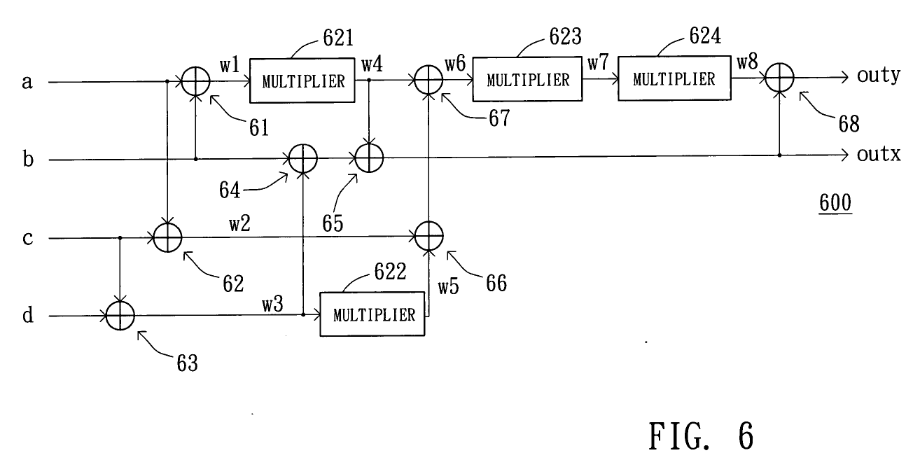

In the following example, a key expansion operation (KeyExpansion) device is provided to selectively produce either the previous subkey or the next subkey, based on an input subkey, wherein the input subkey is referred to as given subkey and the subkey to be produced by KeyExpansion is referred to as desired subkey. The following will describe the operation of KeyExpansion. FIG. 7A illustrates the operation of determining the next subkey of an input subkey based on the input subkey. The input subkey is denoted by SubKey(i) and the next subkey is denoted by SubKey(i+1). Suppose the subkeys are of 128 bits and are represented as 4×4 matrices, each of which has four columns of bytes. As shown in FIG. 7A, data column 1, i.e., bytes in column 1, of a subkey, such as SubKey(i) or SubKey(i+1), consists of elements k0 to k3 (or denoted by k[3:0]); data column 2, i.e., bytes in column 2, consists of elements k4 to k7 (or k[7:4]); data column 3, i.e., bytes in column 3, consists of elements k8 to k11 (or k[11:8]); and data column 4, i.e., bytes in column 4, consists of elements k12 to k15 (or k[15:12]). First, a column data converting device 750 converts data column 4 of SubKey(i) into special data column 752. In the column data converting device 750, (1) a “rotate byte right” operation is first performed on the input data, (2) EX-OR operation is to be perform on the first byte of the input data after the rotate byte right operation and a round constant Rcon[i], and (3) a 4-byte result from (2) is outputted, thereby producing the special data column 752. For the round constant Rcon[i], i is indicative of the round number and determines the value of Rcon. According to the definition in AES, Rcon[0]=1 and Rcon[i]=Xtime(Rcon[i−1]). Next, EX-OR gate 71 performs EX-OR operation on the special data column 752 and data column 1 of the SubKey(i), resulting in data column 1 of the SubKey(i+1). EX-OR gate 72 performs EX-OR operation on the data column 2 of the SubKey(i) and the data column 1 of the SubKey(i+1), resulting in data column 2 of the SubKey(i+1). Likewise, EX-OR gate 73 performs EX-OR operation on the data column 3 of the SubKey(i) and the data column 2 of the SubKey(i+1), resulting in data column 3 of the SubKey(i+1). Finally, EX-OR gate 74 performs EX-OR operation on the data column 4 of the SubKey(i) and the data column 3 of the SubKey(i+1), resulting in data column 4 of the SubKey(i+1).

FIG. 7B illustrates the operation of determining the previous subkey of an input subkey based on the input subkey. First, the EX-OR gate 74 performs EX-OR operation on the data column 3 of the SubKey(i+1) and the data column 4 of the SubKey(i+1), resulting in the data column 4 of the SubKey(i). The data column 4 of the SubKey(i) is then converted into special data column 752 by the column data converting device 750. The special data column 752 is fed into the EX-OR gate 71, and the EX-OR gate 71 performs EX-OR operation on the special data column 752 and the data column 1 of the SubKey(i+1), resulting in the data column 1 of the SubKey(i). As shown in FIG. 7B, the EX-OR gate 72 performs EX-OR operation on the data column 1 of the SubKey(i+1) and the data column 2 of the SubKey(i+1), resulting in the data column 2 of the SubKey(i). Similarly, EX-OR gate 73 performs EX-OR operation on the data column 2 of the SubKey(i+1) and the data column 3 of the SubKey(i+1), resulting in the data column 3 of the SubKey(i).

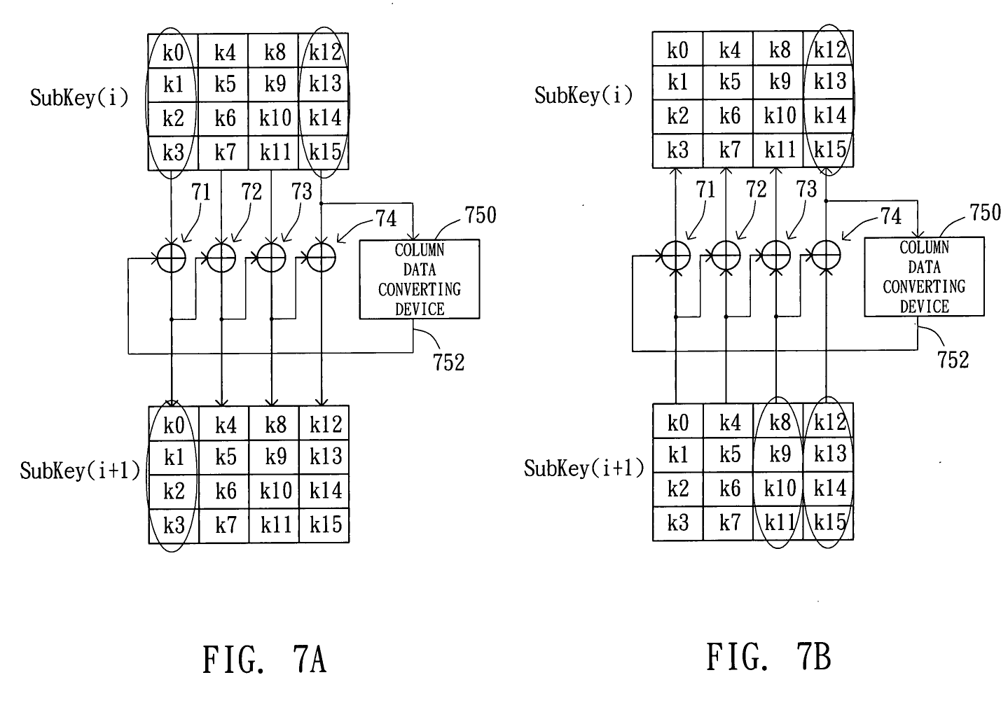

FIG. 8 illustrates a key expansion (KeyExpansion) module 800. The KeyExpansion module 800 includes the EX-OR gates 71, 72, 73, 74, multiplexers 710, 720, 730, 740, and the column data converting device 750. The input data code (denoted by “in”) is the current subkey (i.e., the given subkey) and the output data code (denoted by “out”) may be either the next subkey or the previous subkey, (i.e., the desired subkey). Each of the multiplexers has an input terminal 0 and input terminal 1 and selectively outputs data from one of the input terminals according to a selection signal (denoted by “ec”). When the selection signal ec is set to 1, the desired subkey is the next subkey. When the selection signal ec is set to 0, the desired subkey is the previous subkey. As shown in FIG. 8, data column 1 of the given subkey is fed into the EX-OR gate 71 and the input terminal 0 of the multiplexer 710. Data column 2 of the given subkey is fed into the EX-OR gate 72 and the input terminal 0 of the multiplexer 720. Data column 3 of the given subkey is fed into the EX-OR gate 73 and the input terminal 0 of the multiplexer 730. Data column 4 of the given subkey is fed into the EX-OR gate 74 and the input terminal 0 of the multiplexer 740. In addition, the output data of the EX-OR gate 71 is the data column 1 of the desired subkey and is fed into the input terminal 1 of the multiplexer 710. The output data of the EX-OR gate 72 is the data column 2 of the desired subkey and is fed into the input terminal 1 of the multiplexer 720. The output data of the EX-OR gate 73 is the data column 3 of the desired subkey and is fed into the input terminal 1 of the multiplexer 730. The output data of the EX-OR gate 74 is the data column 4 of the desired subkey and is fed into the input terminal 0 of the multiplexer 740. In the following description, the operations of KeyExpansion and InvKeyExpansion implemented in the KeyExpansion module 800 are to be described.

KeyExpansion is to output the next subkey, i.e., desired subkey, of an input subkey, i.e., given subkey, based on the input subkey. When the selection signal ec is set to 1, the data column 4 of the given subkey can be converted into the special data column 752 by the column data converting device 750 via the multiplexer 740. The special data column 752 is then fed into the EX-OR gate 71, and the EX-OR gate 71 performs EX-OR operation on the special data column 752 and the data column 1 of the given subkey, resulting in the data column 1 of the next subkey. As can be derived from FIG. 8, where the selection signal ec is set to one, the data column 1 of the next subkey is fed into the EX-OR gate 72 through the multiplexer 710, and the EX-OR gate 72 performs EX-OR operation on the data column 1 of the next subkey and the data column 2 of the given subkey, resulting in the data column 2 of the next subkey. The data column 2 of the next subkey is fed into the EX-OR gate 73 through the multiplexer 720, and the EX-OR gate 73 performs EX-OR operation on the data column 2 of the next subkey and the data column 3 of the given subkey, resulting in the data column 3 of the next subkey. The data column 3 of the next subkey is fed into the EX-OR gate 74 through the multiplexer 730, and the EX-OR gate 74 performs EX-OR operation on the data column 3 of the next subkey and the data column 4 of the given subkey, resulting in the data column 4 of the next subkey.

InvKeyExpansion is to output the previous subkey, i.e., desired subkey, of an input subkey, i.e., given subkey, based on the input subkey. When the selection signal is set to 0, the data column 3 of the given subkey is fed into the EX-OR gate 74 through the multiplexer 730, and the EX-OR gate 74 performs EX-OR operation on the data column 3 of the given subkey and the data column 4 of the given subkey, resulting in the data column 4 of the previous subkey. Next, the data column 4 of the previous subkey is fed into the column data converting device 750 through the multiplexer 740, so as to obtain the special data column 752. The special data column 752 is then fed into the EX-OR gate 71, and the EX-OR gate 71 performs EX-OR operation on the special data column 752 and the data column 1 of the given subkey, resulting in the data column 1 of the previous subkey. As can be derived from FIG. 8, where the selection signal ec is set to 0, the data column 1 of the given subkey is fed into the EX-OR gate 72 through the multiplexer 710, and the EX-OR gate 72 performs EX-OR operation on the data column 1 of the given subkey and the data column 2 of the given subkey, resulting in the data column 2 of the previous subkey. The data column 2 of the given subkey is fed into the EX-OR gate 73 through the multiplexer 720, and the EX-OR gate 73 performs EX-OR operation on the data column 2 of the given subkey and the data column 3 of the given subkey, resulting in the data column 3 of the previous subkey.

As disclosed in the embodiments above, the integrated SubBytes/InvSubBytes module for supporting AES encryption and decryption according to the embodiments of the invention has the advantage that the circuit module benefits from the reduction of the entire critical paths and complexity, as well as the application of a common look-up table on each of the operations, thus improving the speed of operation and saving the operation resources.

Thus, the round module supporting AES and the AES encryption and decryption apparatus according to the embodiments of the invention also have the above advantage. Further, the round module has an integrated MixColumns/InvMixColumns module, saving the operational resources. Therefore, the AES encryption and decryption apparatus uses less operational resources, reduced hardware complexity, and improved operation performance.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An apparatus for selectively performing byte substitution operation (SubBytes) and inverse byte substitution operation (InvSubBytes) on an input data code so as to output a required output data code, the apparatus supporting advanced encryption standard (AES), the apparatus comprising:
a first matrix operation module for performing a first matrix operation on the input data code and outputting the result of the first matrix operation;
a first exclusive-OR operation module for performing a first exclusive-OR operation on the input data code and outputting the result of the first exclusive-OR operation;
a first multiplexer, coupled to the first matrix operation module and the first exclusive-OR operation module, for selecting either the result of the first exclusive-OR operation or the result of the first matrix operation, according to a selection signal, as an output data code of the first multiplexer;
a table-lookup operation module, coupled to the first multiplexer, for performing a table-lookup operation so as to output a table-lookup data code according to the output data code from the first multiplexer;
a second matrix operation module, coupled to the table-lookup operation module, for performing a second matrix operation on the table-lookup data code and outputting the result of the second matrix operation;
a second exclusive-OR operation module for performing a second exclusive-OR operation on the table-lookup data code and outputting the result of the second exclusive-OR operation; and
a second multiplexer, coupled to the second matrix operation module and the second exclusive-OR operation module, for selecting one of the result of the second matrix operation and the result of the second exclusive-OR operation, according to the selection signal, as an output data code of the second multiplexer;
wherein the output data code from the second multiplexer is the required output data code for the apparatus.

2. The apparatus according to claim 1, wherein the apparatus performs byte substitution operation when the selection signal is indicative of encryption, wherein the first multiplexer selects the result of the first exclusive-OR operation and the second multiplexer selects the result of the second exclusive-OR operation.

3. The apparatus according to claim 1, wherein the apparatus performs inverse byte substitution operation when the selection signal is indicative of decryption, wherein the first multiplexer selects the result of the first matrix operation and the second multiplexer selects the result of the second matrix operation.

4. The apparatus according to claim 1, wherein the first matrix operation is substantially identical to the second matrix operation.

5. The apparatus according to claim 1, wherein the first exclusive-OR operation has an operand based on the first matrix operation and the second exclusive-OR operation.

6. The apparatus according to claim 1, wherein the table-lookup operation module has a look-up table based on a multiplicative inverse operation, the first matrix operation, and the first exclusive-OR operation.

7. A round module for supporting advanced encryption standard (AES) to perform encryption or decryption operation selectively on an input data code with a subkey and output an output data code, the round module comprising:
a bitwise exclusive-OR (EX-OR) device for performing bitwise exclusive-OR (EX-OR) operation on the input data code and the subkey so as to output a first output code;
a first multiplexer, coupled to the EX-OR device, wherein the first multiplexer, according to a selection signal, selectively outputs one of the cipher data code and the first output code as a first product code;
a byte-substitution/inverse-byte-substitution operation (SubBytes/InvSubBytes) module, coupled to the first multiplexer, for selectively performing byte-substitution/inverse-byte-substitution operation (SubBytes/InvSubBytes) on the first output code so as to output a substitution output code, the SubBytes/InvSubBytes module comprising:
a first matrix operation module for performing a first matrix operation on the first output code and outputting the result of the first matrix operation;
a first exclusive-OR operation module for performing a first exclusive-OR operation on the first output code and outputting the result of the first exclusive-OR operation;
a first selector, coupled to the first matrix operation module and the first exclusive-OR operation module, for selecting either the result of the first exclusive-OR operation or the result of the first matrix operation, according to the selection signal, as an output data code of the first selector;
a table-lookup operation module, coupled to the first selector, for performing a table-lookup operation so as to output a table-lookup data code according to the output data code from the first selector;
a second matrix operation module for performing a second matrix operation on the table-lookup data code and outputting the result of the second matrix operation;
a second exclusive-OR operation module for performing a second exclusive-OR operation on the table-lookup data code and outputting the result of the second exclusive-OR operation; and
a second selector, coupled to the second matrix operation module and the second exclusive-OR operation module, for selecting one of the result of the second matrix operation and the result of the second exclusive-OR operation, according to the selection signal, as the substitution output code;
a row-shifting/inverse-row-shifting operation (ShiftRows/InvShiftRows) module, coupled to the SubBytes/InvSubBytes module, for selectively performing row-shifting/inverse-row-shifting operation (ShiftRows/InvShiftRows) on the substitution output code so as to output a shifted code;
a second multiplexer, coupled to the EX-OR device and the ShiftRows/InvShiftRows module, wherein the second multiplexer, according to the selection signal, selectively outputs one of the first output code and the shifted code as a second product code;
a column-mixing/inverse-column-mixing operation (MixColumns/InvMixColumns) module, coupled to the second multiplexer, for selectively performing column-mixing/inverse-column-mixing operation (MixColumns/InvMixColumns) on the second product code so as to output a mixed code;
a third multiplexer, coupled to the second multiplexer and the MixColumns/InvMixColumns module, according to a cipher detection signal, for selectively outputting one of the second product code and the mixed code as a third product code, wherein the third product code is the cipher data code;
a fourth multiplexer, coupled to the third multiplexer and the ShiftRows/InvShiftRows module, wherein the fourth multiplexer, according to the selection signal, selectively outputs one of the shifted code and the cipher data code as a fourth product code; and
a fifth multiplexer, coupled to the fourth multiplexer and the EX-OR device, wherein the fifth multiplexer, according to a round detection signal, selectively outputs one of the fourth product code and the first output code as the output data code for the apparatus.

8. The round module according to claim 7, wherein the SubBytes/InvSubBytes module performs byte substitution operation when the selection signal is indicative of encryption, wherein the first selector selects the result of the first exclusive-OR operation and the second selector selects the result of the second exclusive-OR operation.

9. The round module according to claim 7, wherein the SubBytes/InvSubBytes module performs inverse byte substitution operation when the selection signal is indicative of decryption, wherein the first selector selects the result of the first matrix operation and the second selector selects the result of the second matrix operation.

10. The round module according to claim 7, wherein the first matrix operation is substantially identical to the second matrix operation.

11. The round module according to claim 7, wherein the first exclusive-OR operation has an operand based on the first matrix operation and the second exclusive-OR operation.

12. The round circuit module according to claim 7, wherein the table-lookup operation module has a look-up table based on a multiplicative inverse operation, the first matrix operation, and the first exclusive-OR operation.

13. An apparatus for performing advanced encryption standard (AES) encryption and decryption selectively on an input data code so as to produce an output data code, the apparatus comprising:
a round operation device for performing a round operation with respect to either encryption or decryption selectively on an input code and a subkey so as to output a round operation output code;
a key expansion operation device, coupled to the round operation module, for generating the subkey for the round operation with respect to either encryption or decryption selectively, wherein the subkey is a desired subkey based on a given subkey; and
a key storage device, coupled to the round operation device and the key expansion operation device, for subkey storage and distribution so as to enable the round operation device and the key expansion operation device to perform the round operation;
wherein the round operation device comprises a byte-substitution/inverse-byte-substitution operation (SubBytes/InvSubBytes) module, for selectively performing byte-substitution/inverse-byte-substitution operation (SubBytes/InvSubBytes) on an operation input code which is based on the input code and subkey received by the round operation device so as to output a substitution output code, the SubBytes/InvSubBytes module comprising:
a first matrix operation module for performing a first matrix operation on the operation input code and outputting the result of the first matrix operation;
a first exclusive-OR operation module for performing a first exclusive-OR operation on the operation input code and outputting the result of the first exclusive-OR operation;
a first selector, coupled to the first matrix operation module and the first exclusive-OR operation module, for selecting one from the result of the first exclusive-OR operation and the result of the first matrix operation, according to the selection signal, as an output code of the first selector;
a table-lookup operation module, coupled to the first selector, for performing a table-lookup operation so as to output a table-lookup data code according to the output code of the first selector;
a second matrix operation module for performing a second matrix operation on the table-lookup data code and outputting the result of the second matrix operation;
a second exclusive-OR operation module for performing a second exclusive-OR operation on the table-lookup data code and outputting the result of the second exclusive-OR operation; and
a second selector, coupled to the second matrix operation module and the second exclusive-OR operation module, for selecting one from the result of the second matrix operation and the result of the second exclusive-OR operation, according to the selection signal, as the substitution output code;
wherein the key storage device receives the round operation output code and receives the subkey from the key expansion operation device; the key storage device outputs the given subkey to the key expansion operation device and outputs the input code to the round operation device; the key storage device buffers the input data code, performs subkey storage and distribution, receives the round operation output code and the subkey generated by the key expansion operation device, and outputs the output data code.

14. The apparatus according to claim 13, wherein the key expansion operation device generates the desired subkey based on the given subkey, wherein the given subkey and the desired subkey are two consecutive subkeys, and each of the given subkey and the desired subkey comprises a first data column, a second data column, a third data column, a fourth data column, the key expansion operation device comprises:
a column data converting device, for converting a data column into a special data column and outputting the special data column;
a first bitwise exclusive-OR (EX-OR) device, for performing bitwise exclusive-OR (EX-OR) operation on the first data column of the given subkey and the special data column so as to output a first output code, wherein the first output code is the first data column of the desired subkey;
a first multiplexer, coupled to the first EX-OR device, having a first input terminal and a second input terminal, wherein the first multiplexer, according to the selection signal, selectively outputs one data column from the first data column of the given subkey and the first data column of the desired subkey;
a second EX-OR device, for performing EX-OR operation on the second data column of the given subkey and the one data column outputted by the first multiplexer so as to output a second output code, wherein the second output code is the second data column of the desired subkey;
a second multiplexer, coupled to the second EX-OR device, wherein the second multiplexer, according to the selection signal, selectively outputs one data column from the second data column of the given subkey and the second column of the desired subkey;
a third EX-OR device, for performing EX-OR operation on the third data column of the given subkey and the one data column outputted by the second multiplexer so as to output a third output code, wherein the third output code is the third data column of the desired subkey;
a third multiplexer, coupled to the third EX-OR device, wherein the third multiplexer, according to the selection signal, selectively outputs one data column from the third data column of the given subkey and the third column of the desired subkey;
a fourth EX-OR device, for performing EX-OR operation on the fourth data column of the given subkey and the one data column outputted by the third multiplexer so as to output a fourth output code, wherein the fourth output code is the fourth data column of the desired subkey; and
a fourth multiplexer, coupled to the fourth EX-OR device, wherein the fourth multiplexer, according to the selection signal, selectively outputs one data column from the fourth data column of the given subkey and the fourth data column of the desired subkey, and the one data column outputted by the fourth multiplexer is the data column which is converted into the special data column by the column data converting device.

15. The apparatus according to claim 13, wherein the SubBytes/InvSubBytes module performs byte substitution operation when the selection signal is indicative of encryption, wherein the first selector selects the result of the first exclusive-OR operation and the second selector selects the result of the second exclusive-OR operation.

16. The apparatus according to claim 13, wherein the SubBytes/InvSubBytes module performs inverse byte substitution operation when the selection signal is indicative of decryption, wherein the first selector selects the result of the first matrix operation and the second selector selects the result of the second matrix operation.

17. The apparatus according to claim 13, wherein the first matrix operation is substantially identical to the second matrix operation.

18. The apparatus according to claim 13, wherein the first exclusive-OR operation has an operand based on the first matrix operation and the second exclusive-OR operation.

19. The apparatus according to claim 13, wherein the table-lookup operation module has a look-up table based on a multiplicative inverse operation, the first matrix operation, and the first exclusive-OR operation.
